(19) United States
(12) Patent Application Publication
(10) Pub. No.: US 2018/0224942 A1
(43) Pub. Date: Aug. 9, 2018

(54) METHOD AND SYSTEM FOR NAVIGATION OF CONTENT IN VIRTUAL IMAGE DISPLAY DEVICES

(71) Applicant: International Business Machines Corporation, Armonk, NY (US)

(72) Inventor: Sarbajit K. Rakshit, Kolkata (IN)

(21) Appl. No.: 15/423,680

(22) Filed: Feb. 3, 2017

(51) Int. Cl. G06F 3/01

(52) U.S. Cl. CPC G06F 3/017; G06F 3/011

(57) ABSTRACT

A method, a system and a computer product for accessing content on a virtual image display device is provided. The method includes: receiving, by a user, multiple discrete virtual-image content segments on the virtual-image display device, each of the multiple discrete virtual-image content segments comprising the content; coalescing, by an operating system of the virtual-image display device, each content segment of the multiple discrete virtual-image content segments homogenously into at least one content cluster, each of the at least one content cluster being displayed in a radial virtual-image area, at least in part, within the virtual-image display device; and accessing the content of each content cluster of the at least one content cluster, at least in part, by gesturing along a periphery of the virtual-image display device.

### RELATED APPLICATIONS

The application is related to the co-pending and commonly assigned U.S. patent application Ser. No. 15/339,980, filed on Nov. 1, 2016, entitled “METHOD AND SYSTEM FOR GENERATING MULTIPLE VIRTUAL IMAGE DISPLAYS”, the contents of which are incorporated herein by reference in its entirety.

### BACKGROUND

The present invention relates generally to a method and a system for generating virtual image displays, and more particularly, to a method and system for navigating content of infinite number of virtual images displayed in a plurality of virtual-image display areas, for instance, of a virtual image display device.

In one aspect, conventional image display screens, such as, LED, LCD panels, of a display device (such as, for instance, iPhone, iPad, laptop, TV, etc) are often limited by the number of physical panels which, in turn, could restrict the viewing area of the display device. As understood, display devices with an enlarged image display screens continue to be fabricated to overcome this deficiency. As the size of the technology nodes continue to decrease, significant challenges continue to arise due (in part) to issues related to cost and complexity of fabrication process.

As an enhancement to conventional physical image display screens, virtual-image display devices, for instance, that utilize conventional lenses and reflective elements have been developed. However, virtual-image display devices typically exhibit single virtual image that is a magnified version of the real image.

Further enhancements in virtual-image display devices continue to be pursued for enhanced performance and commercial advantage.

### SUMMARY

In one aspect of the present application, a method for accessing content on a virtual image display device is provided. The method includes: receiving, by a user, multiple discrete virtual-image content segments on the virtual-image display device, each of the multiple discrete virtual-image content segments comprising the content; coalescing, by an operating system of the virtual-image display device, each content segment of the multiple discrete virtual-image content segments homogenously into at least one content cluster, each of the at least one content cluster being displayed in a radial virtual-image area, at least in part, within the virtual-image display device; and accessing the content of each content cluster of the at least one content cluster, at least in part, by gesturing along a periphery of the virtual-image display device.

According to an embodiment, the coalescing includes coalescing each content segment of the multiple discrete virtual-image content segments based on at least one rule that is defined by the user, the at least one rule being at least one of a cluster logic rule and a cluster prioritization rule.

According to an embodiment, the radial virtual-image area is a radial virtual-image area of a plurality of radial virtual-image areas, with each of the plurality of radial virtual-image areas is discretely displayed, at least in part, within the virtual-image display device, wherein a total number of the plurality of radial virtual-image areas is defined by the content of each of the at least one content cluster.

According to an embodiment, the method further includes modifying a dimension of each of the plurality of radial virtual-image areas to facilitate enhancing visual clarity thereof, wherein the dimension of each of the plurality of radial virtual-image areas is modified by gesturing at a periphery of the virtual-image display device.

According to an embodiment, the coalescing includes laterally spacing apart the radial virtual-image area from the remaining radial virtual-image areas a distance that allows the enhanced visual clarity thereof.

According to an embodiment, the accessing includes gesturing linearly to select the content cluster of the at least one content cluster, and navigating the content cluster by rotating along the periphery of the virtual-image display device.

According to an embodiment, the accessing includes interchanging the positioning of each content cluster of the at least one content cluster, at least in part, by gesturing interchangeably along the periphery of the virtual-image display device.

According to an embodiment, the receiving includes providing the virtual image display device, the virtual image display device comprising: a housing having an open end and a closed end with a plurality of sidewalls extending between the open end and the closed end; a primary display area at the closed end; a sidewall display area on each of the plurality of sidewalls; and a computer within the housing operably connected to the primary display area and each of the sidewall display areas; generating a virtual-image display area opposing each sidewall display area; generating a plurality of secondary virtual-image display areas extending outwardly from the virtual-image display areas; and aggregating the primary display area, each of the virtual-image display areas, and each of the secondary virtual-image display areas to create a cumulative virtual-image display area, the cumulative virtual-image display area comprising each of the multiple discrete virtual-image content segments.

According to an embodiment, the method further includes the steps of: providing a sensor within the housing; sensing gestures with the sensor; and transmitting a signal from the sensor to the computer.

According to another aspect of the present application, a computer program product, for use with a virtual image display device, embodied in a non-transitory computer-readable storage medium and including instructions that when executed by a processor perform a method for accessing content on the virtual image display device, the method including: receiving, by a user, multiple discrete virtual-image content segments on the virtual-image display device, each of the multiple discrete virtual-image content segments comprising the content; coalescing, by an operating system of the virtual-image display device, each content segment of the multiple discrete virtual-image content segments homogenously into at least one content cluster, each content cluster of the at least one content cluster being displayed in a radial virtual-image area, at least in part, within the virtual-image display device; and accessing the content of each content cluster of the at least one content cluster, at least in part, by gesturing along a periphery of the virtual-image display device.

According to yet another aspect of the present application, a system for use with a virtual image display device is provided. The system includes: at least one processor; and a computer program product embodied in a non-transitory computer-readable storage medium and including instructions that when executed by a processor of the at least one processor perform a method for accessing content on the virtual image display device, the method including: receiving, by a user, multiple discrete virtual-image content segments on the virtual-image display device, each of the multiple discrete virtual-image content segments comprising the content; coalescing, by an operating system of the processor of the at least one processor, the multiple discrete virtual-image content segments homogenously into at least one content cluster, each of the at least one content cluster being displayed in a radial virtual-image area, at least in part, within the virtual-image display device; and accessing the content of each content cluster of the at least one content cluster, at least in part, by gesturing along a periphery of the virtual-image display device.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1A depicts an isometric view of one embodiment of a system including a virtual-image display device, in accordance with an aspect of the present invention.

FIG. 1B depicts one embodiment of a method for creating one or more virtual-image display areas of the virtual-image display device, in accordance with an aspect of the present invention.

FIG. 1C depicts one embodiment of a method for creating a radial virtual-image area of the virtual-image display device, in accordance with an aspect of the present invention.

FIG. 1D depicts one embodiment of a method for creating additional radial virtual-image areas of the virtual-image display device, in accordance with an aspect of the present invention.

FIGS. 2A-2C depicts an isometric view of alternate embodiments of a system including virtual-image display device(s), in accordance with one or more aspects of the present invention.

FIG. 3 illustrates a flowchart that describes a method for accessing content area(s) of the virtual-image display device, in accordance with an aspect of the present invention.

FIG. 4 depicts one embodiment of a computer program product incorporating one or more aspects of the present invention.

### DETAILED DESCRIPTION

The present invention is directed to, inter alia, embodiments of a method, a system and a computer program product for accessing content on a virtual-image display device. By way of example, the present invention relates to, for instance, a virtual-image display device that can display infinite number of virtual images of one or more content segment(s), thereby providing a user with an infinitesimal viewing access to the content segment(s). Advantageously, the method, system and computer program product disclosed herein facilitate the user to navigate the infinite number of virtual images to access the content of the infinite number of content segment(s).

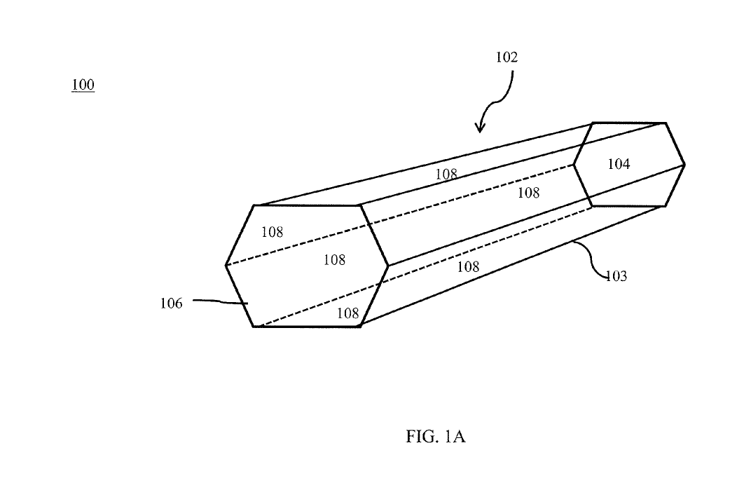

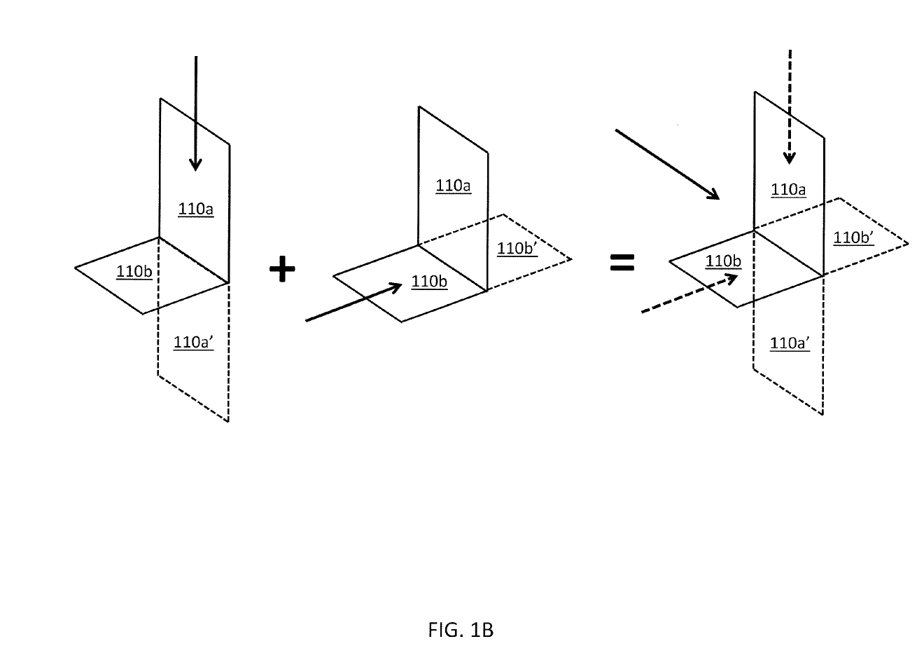

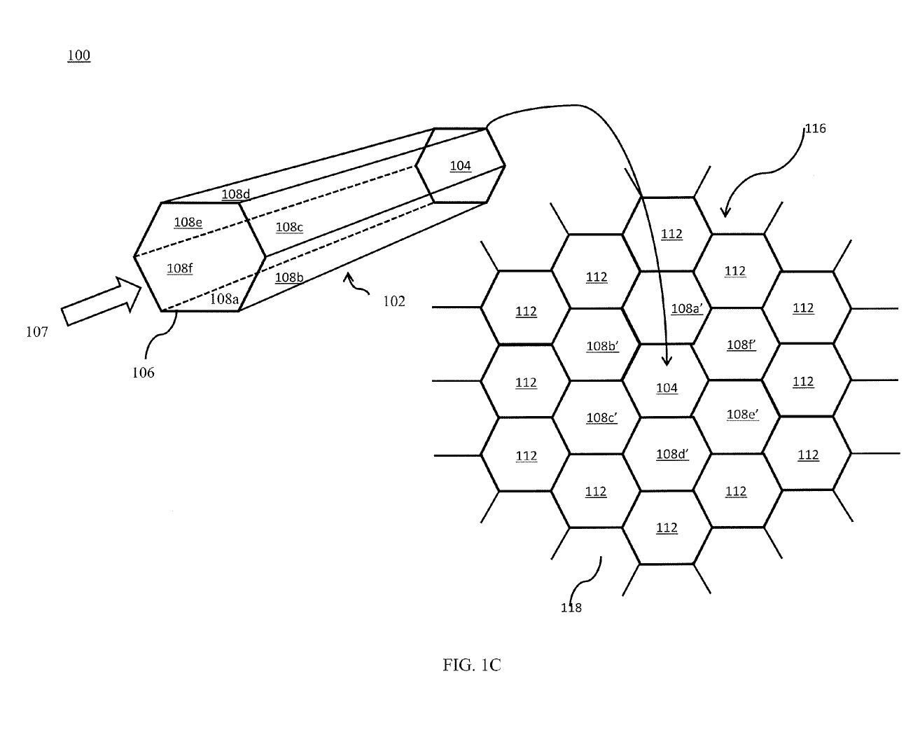

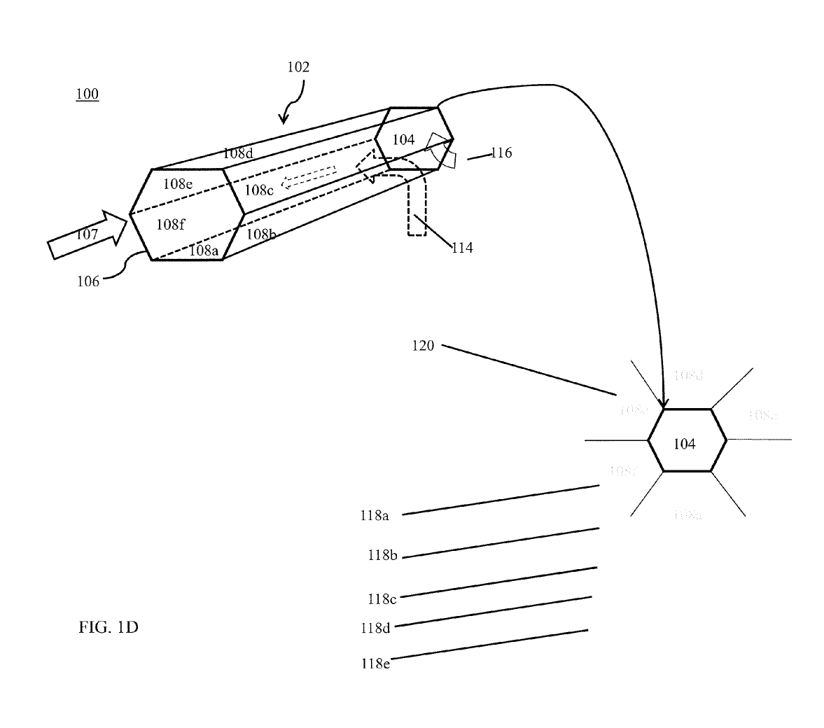

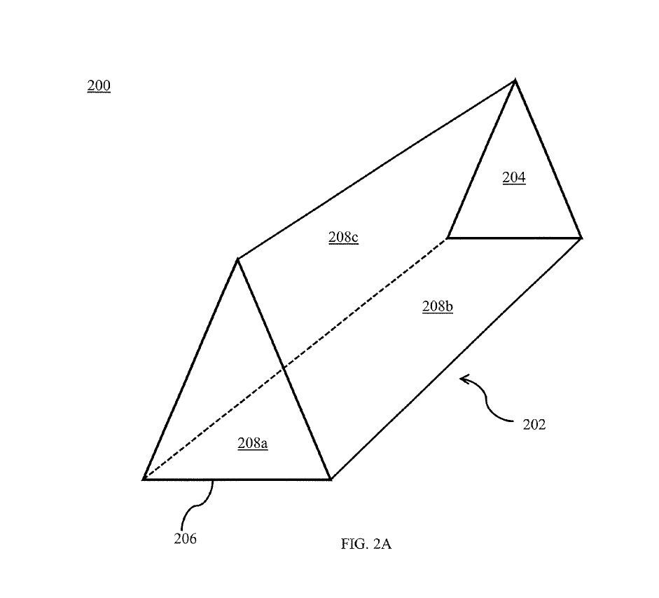

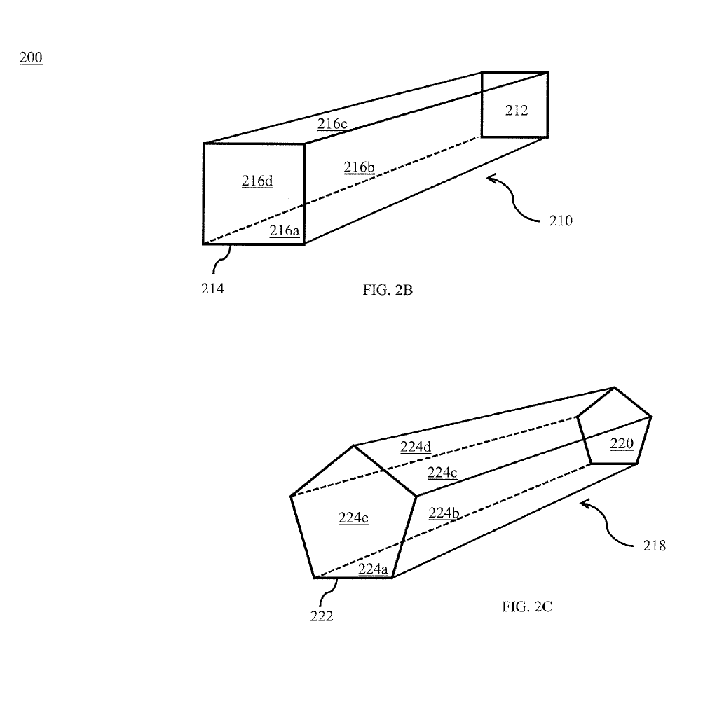

FIG. 1A depicts an isometric view of one embodiment of system 100 including virtual-image display device 102, in accordance with an aspect of the present invention. As depicted, virtual-image display device 102 may be defined (at least in part) by housing (or an enclosure) 103 having closed end 104, and an opposing open end 106. By way of example, closed end 104 of housing 103 may be connected to open end 106 by one or more sidewalls 108 that extend from closed end 104. Specifically, virtual-image display device 102 is depicted in FIG. 1A in the approximate form of an exemplary tubular shape, with a hexagonal cross-sectional shaped closed end 104 and open end 106, respectively. In another example, the cross-section of virtual-image display device 102 may also be triangular (see FIG. 2A), or any regular polygon, such as, square (see FIG. 2B), pentagonal (see FIG. 2C) or the like.

Continuing with FIG. 1A, sidewalls 108 of housing 103, in one example, may be permanently connected or releasably connected. For instance, in the case of releasably connected sidewalls 108, the sidewalls of virtual-image display device 102 may be released so as to unfold housing 103 to be substantially planar. By way of example, each sidewall 108 of housing 103 depicted in FIG. 1A forms a sidewall display area along an inner surface of housing 103. Note that, as depicted, each of the sidewall display areas along the inner surface of virtual-image display device 102 are in an angular configuration which, for instance, facilitates creating one or more virtual-image display areas along the inner surface of virtual-image display device 102. As discussed further below, these virtual-image display areas can display infinite number of virtual images of the one or more content segment(s)(referred to herein as “virtual-image content segment(s)”) that are displayed on the primary display area located at closed end 104. Such infinite number of virtual-image content segment(s), for instance, facilitates providing a user with an infinitesimal viewing access to the content segment(s) of the primary display area located at closed end 104, as described further below.

Continuing further with FIG. 1A, housing 103 of virtual-image display device 102 may be dimensioned such that a geometry (such as, area, diameter, perimeter or the like) of closed end 104 may be different than a geometry of open end 106. In one example, housing 103 may be tapered such that the area of open end 106 may be larger than the area of closed end 104. Note that, in one embodiment, such an enlarged open end 106 with an optimal angular configuration provides enhanced visual clarity of the virtual-image content segment(s) that are displayed, at least in part, within virtual-image display device 102, when a user looks into housing 103 thereof, as discussed further below.

Additionally, virtual-image display device 102 (see FIG. 1A) may also include a computer (not shown) that includes, for instance, a processor, a power source, a transmitter, a memory and a controller. In one embodiment, the computer (not shown) may include computer-readable program instructions, which when executed by the processor, create each of the virtual-image content segment(s) and facilitate one or more aspects of the present invention.

Although not bound by theory, the creating of each virtual-image display area, at least in part, within the virtual-image display device may be better understood using the example depicted in FIG. 1B. By way of example only, display area 110a may be connected to and perpendicularly intersect an additional display area 110b. Note that, each of these display areas (e.g., display areas 110a, 110b) may be utilized to display a content segment having content that is either similar or different from each other. In such an example, when viewed parallel to (e.g., along the direction) of display area 110a, virtual-image display area 110a′ (for instance, that mimics a mirror-like reflection of display area 110a) may be created that extends from and is disposed in spaced opposing relation to display area 110a, while display area 110b may create virtual-image display area 110b′ that extends from and is disposed in spaced opposing relation to display area 110b, as depicted in FIG. 1B. Note that, as depicted in FIG. 1B, each of the virtual-image display areas, i.e., virtual-image display areas 110a′ and 110b′, may appear to be connected to and perpendicularly intersecting with each other, when viewed into an intersection of the display areas 110a, 110b.

Note that the theory of the example described in FIG. 1B can be extended to better understand one or more aspects of the present invention. In one embodiment, the processor (not shown) executes computer-readable program instructions to mimic mirror-like reflections of one or more content segments that are displayed, for instance, on the primary display area located at closed end 104 of virtual-image display device 102, as depicted in FIG. 1C. By way of example, in one embodiment, closed end 104 defines a primary display area that may be utilized to display one or more content segments, with each content segments having content that is either similar or different from each other. Note that, in one example, the primary display area (i.e., of closed end 104) can function as the viewing area that is located, at least in part, within virtual-image display device 102. As described above, each sidewall 108 (see FIG. 1A) disposed adjacent to closed end 104 forms a sidewall display area along an inner surface of virtual-image display device 102.

As understood, in one example, each of the sidewall display areas, i.e., sidewall display areas 108a, 108b, 108c, 108d, 108e and 108f, of virtual-image display device 102 generate mirror-like reflections, thereby creating virtual-image display areas 108a′, 108b′, 108c′, 108d′, 108e′ and 108f′, respectively, within an inner surface of virtual-image display device 102. Note that these virtual-image display areas 108a′, 108b′, 108c′, 108d′, 108e′ and 108f′, respectively, are similar to virtual-image display areas 110a′ and 110b′ described above in connection with FIG. 1B. In a specific example, sidewall display area 108a creates a virtual-image display area 108a′ that is in spaced opposing relation to sidewall display area 108a, while sidewall display area 108b creates a virtual-image display area 108b′ that is in spaced opposing relation to sidewall display area 108b, and so on. Note that, as depicted, each of the virtual-image display areas 108a′, 108b′, 108c′, 108d′, 108e′ and 108f′, respectively, surround primary display area (for instance, that is located at the closed end) 104, when a user 107 views into virtual-image display device 102 through open end 106.

Additionally, each of the virtual-image display areas 108a′, 108b′, 108c′, 108d′, 108e′ and 108f′, in turn, may create secondary virtual-image display areas 112, based on the computer-readable program instructions, resulting in sidewall display areas 108a, 108b, 108c, 108d, 108e and 108f of virtual-image display device 102 to mimic properties of an infinity mirror. As one skilled in the art will understand, an infinity mirror is a set of mirrors, i.e., one fully reflective mirror and one “one-way mirror”, set up so that the one-way or partially reflective mirror reflects an image back onto the fully reflective mirror, in a recursive manner, creating a series of smaller and smaller reflections that appear to recede into an infinite distance. In one embodiment, and although not depicted in the figures, each of the secondary virtual-image display areas 112 create additional secondary virtual-image display areas (not shown) that extend from the main display area 104 creating a series of smaller and smaller virtual-image display areas that can appear to recede into an infinite distance, for instance, similar to the mimicking of the infinity mirror effect.

Continuing further with FIG. 1C, in an additional, or alternate embodiment, although the geometry (such as, for instance, area) of the primary display area located at closed area 104 is limited (i.e., dependent on the geometry of closed area 104), each of the virtual-image display areas, the secondary virtual-image display areas and the additional secondary virtual-image display areas can be aggregated to create a cumulative virtual-image display area 116 that can provide infinite access to the content segment(s) of the primary display area, for instance, by displaying infinite number of virtual-image content segment(s) thereof. Such cumulative virtual-image display area 116, for instance, facilitates providing a user with an infinitesimal viewing access to the content segment(s) of the primary display area. In such example, content of the virtual-image content segment(s) may be transmitted by the processor (not shown) to be projected onto cumulative virtual-image display area 116 that is located, at least in part, within virtual-image display device 102. In another example, content of the virtual-image content segment(s) may be transmitted by the processor (not shown) to be projected onto cumulative virtual-image display area 116 that is located outside virtual-image display device 102.

Disadvantageously, the infinite number of virtual image content segment(s) being displayed on cumulative virtual-image display area 116 may often be discrete and unrelated to each other. For instance, supposing the content segments being displayed on the primary display area at closed end 104 are related to the contents of a social network page (such as, Facebook), the infinite number of virtual image content segment(s) being displayed on cumulative virtual-image display area 116 may be discrete and unrelated to each other. In a specific example, unrelated information related to various friends may be received by the user on the primary display area and the infinite number of virtual-image content segment(s) (for instance, that are discrete) may be displayed on cumulative virtual-image display area 116, at least in part, within virtual-image display device 102. Further, although not critical to the invention, the content of each of these virtual-image content segment(s) that is displayed onto cumulative virtual-image display area 116 may be viewed either as continuous images or isolated images of the content.

In an enhanced embodiment, the processor (not shown) executes computer-readable program instructions to coalesce (i.e., combine) each of the discrete virtual-image content segment(s) homogenously into one or more content cluster(s). For instance, the processor (not shown) executes computer-readable instructions to coalesce and/or sort contents from each of these virtual-image content segment(s) and systematically arrange them into one or more groups, thereby creating each of the content cluster(s). According to an embodiment, each of these content cluster(s), for instance, may be displayed in one or more concentric circles (referred to herein as “radial virtual-image area(s) 118”), with each radial virtual-image having a specific radius, depending on the number of content cluster(s), as depicted in FIG. 1C. Note that, the radial virtual-image areas may be located, at least in part, within virtual-image display device 102.

By way of example, in one embodiment, content(s) of each virtual-image content segment(s) may be coalesced (i.e., combined) based on one or more rule(s) (such as, for instance, cluster logic rule and/or cluster prioritization rule) that is defined by the user. For instance, the user may receive huge amounts (e.g., 1000) of photographs on virtual-image display device 102. In such an example, the user may define that each of these photographs may be coalesced into one or more cluster(s), for instance, based on their metadata and/or contextual information. As understood, in a specific example, each of these discrete photographs may be coalesced based on the user-defined cluster logic rule (such as, for instance, based on groups of friends, semantic content type, such as, travel, sports, and the like) into about 10 individual clusters, with each cluster having about 100 photographs. As used herein “cluster logic rule” refers to the coalescing and/or sorting of discrete virtual-image content segment(s) into one or more content cluster(s) based on their metadata and/or contextual information. Additionally, each of these virtual-image content segment(s) may also be coalesced into individual content cluster(s), for instance, based on priority and/or importance of the content(s) thereof that have been defined by the user. As used herein “cluster prioritization rule” refers to the coalescing and/or combining of discrete virtual-image content segment(s) into one or more content cluster(s), for instance, based on their historical importance.

As depicted in FIG. 1D, different content cluster(s) (i.e., content cluster(s) 118a, 118b, 118c, 118d, and 118e, respectively) may be displayed in different radial virtual-image areas located, at least in part, within virtual-image display device 102. In one example, while the contents of the content cluster displayed in radial virtual-image area 118a may be substantially similar to the contents of the content cluster displayed in radial virtual-image area 118b, the contents of each of these content cluster(s) (e.g., content clusters 118a and 118b) may be limited by the number of contents present in each content cluster. In another example, the contents of content cluster displayed in radial virtual-image area 118a may be substantially different from the contents of content cluster displayed in radial virtual-image area 118b. Additionally, in another embodiment, the total number of contents present in each of the virtual-image content segment(s) may be directly proportional to the number of content cluster(s) created which, in turn, could define the number of radial virtual-image areas displayed, at least in part, within virtual-image display device 102. For instance, an increase in the total number contents (i.e., categories of contents) could result in an increase in the number of content cluster(s). This, in turn, could result in an increase in the number of radial virtual-image areas displayed, at least in part, within virtual-image display device 102.

Still further, according to an embodiment, the processor (not shown) executes computer-readable program instructions to detect an area of interest on the desired content cluster, for instance, by sensing the user's gaze on the respective radial virtual-image area, and may accordingly align the radial virtual-image area into a desired focal area 120 (see FIG. 1D) of the user. Accordingly, one skilled in the art will understand that virtual-image display device 102 may also include one or more sensors (not shown) that can sense movements such as, physical gestures, eye movements and the like, so as to facilitate enhancing the performance of virtual-image display device 102. As understood, each of these sensor(s) may transmit a signal from the sensor to the processor (not shown) of the computer. In this example, the sensor(s) (not shown) can facilitate aligning the desired radial virtual-image area into the viewing area and/or focal area 120 (see FIG. 1D), thereby providing enhanced visual clarity of the corresponding content cluster. Such aligning of the desired radial virtual-image area, for instance, may include adjusting the positioning of the radial virtual-image area such that the desired radial virtual-image area is laterally spaced apart from the remaining radial virtual-image areas. Note that, in one embodiment, such lateral spacing of the desired radial virtual-image area may be based on the prioritization rule defined by the user.

In an additional or an alternate embodiment, the user can select the desired radial virtual-image area so as to access the content present therein, for instance, by gesturing (i.e., moving a finger) linearly along a periphery (i.e., an outer surface) of virtual-image display device 102. This, for instance, facilitates the user to selectively align the desired content of the content cluster into the viewing area and/or focal area 120, at least in part, within virtual image display device 102, thereby providing enhanced visual clarity of the desired content thereof. Additionally, the additional contents of the selected content cluster may also be accessed, for instance, by rotating the finger on the periphery of virtual-image display device 102. Note that, in such example, only the contents present in the selected content cluster will be rotated without disturbing the content cluster(s) of the remaining radial virtual-image areas.

Still further, the user can interchange the positioning of each radial virtual-image area, for instance, by gesturing at the periphery of virtual-image display device 102. For instance, supposing radial virtual-image area 118a displays information related to sports, while radial virtual-image area 118b displays information related to travel, and that radial virtual-image area 118a is present within the viewing area and/or focal area 120 (see FIG. 1D) of the user. In such an example, the user can interchange the positioning of radial virtual-image area 118a with that of radial virtual-image area 118b, for instance, by moving a finger on the outer surface of virtual-image display device 102 to select the desired radial virtual-image area (i.e., radial virtual-image area 118a), and flipping on the outer surface of virtual-image display device 102 so as to swap and/or interchange its position with that of the desired radial virtual image area (i.e., radial virtual-image area 118b).

Additionally, the user can also modify dimensions (such as, area, width and the like) of each radial virtual-image area, for instance, by gesturing (i.e., moving the finger) along a periphery of virtual-image display device 102. As understood, the modification of the dimension of each radial virtual-image area, advantageously, facilitates increasing or decreasing the total number of contents present in the desired content cluster, as well as controlling the visual clarity of the contents therein. Although not depicted in the figures, in an additional or an alternate embodiment, virtual-image display device 102 may be configured with additional hardware resources, such as, keyboard, that may be located at the viewing area and/or focal area 120 (see FIG. 1D) which, for instance, may also be accessed by gesturing (i.e., moving a finger) along the periphery thereof, thereby enhancing the performance of the resultant virtual-image display device 102.

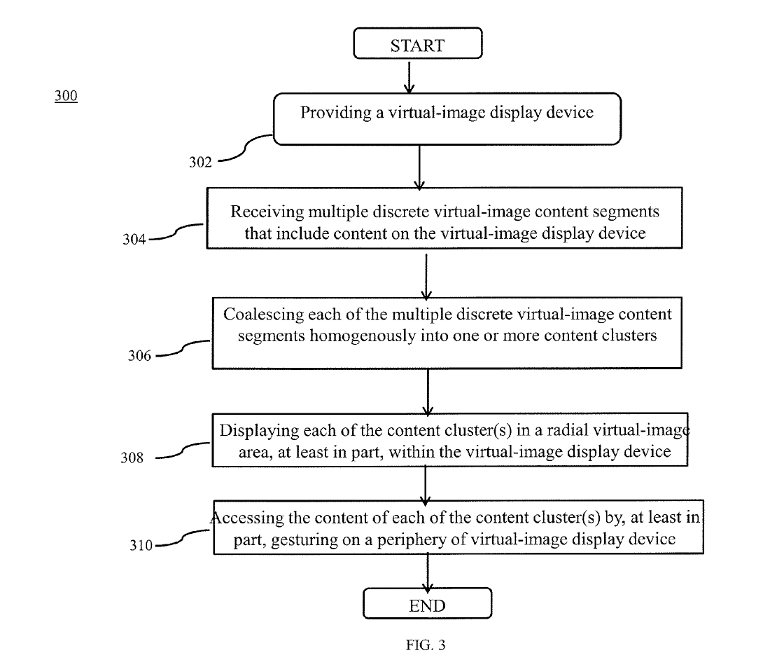

FIG. 3 is an overview of a process 300 for navigating infinite number of virtual images having discrete content segments having content on a virtual-image display device, so as to access content thereof, in accordance with one or more aspects of the present invention. The process 300 begins with providing 302 a virtual-image display device, and receiving 304 multiple discrete virtual-image content segments that include content on the virtual-image display device. Further, the process 300 proceeds to coalesce 306 each content segment of the multiple discrete content segments homogenously into one or more content cluster(s); displaying 308 306 each of the content clusters in a radial virtual-image area, at least in part, within the virtual-image display device; and accessing 308 the content of each of the content cluster of the at least one content cluster, at least in part, by gesturing along a periphery of the virtual-image display device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

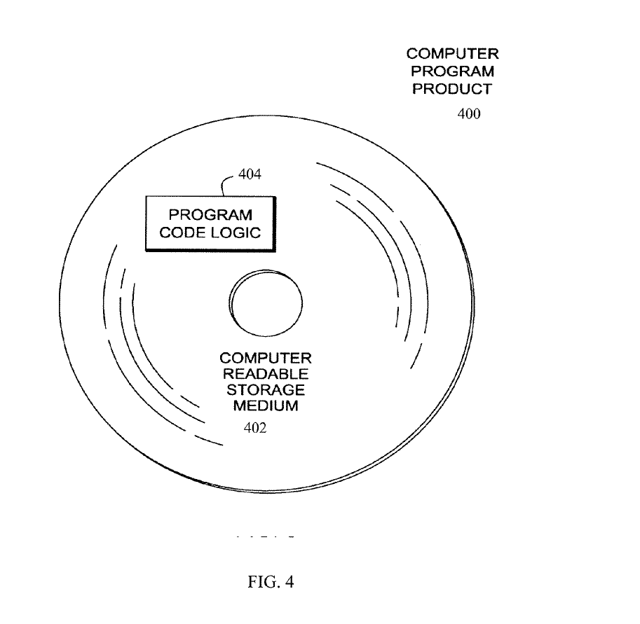

Referring to FIG. 4, in one example, a computer program product 400 includes, for instance, one or more non-transitory computer readable storage media 402 to store computer readable program code means, logic and/or instructions 404 thereon to provide and facilitate one or more embodiments.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for accessing content on a virtual-image display device, the method comprising:
receiving, by a user, multiple discrete virtual-image content segments on the virtual-image display device, each of the multiple discrete virtual-image content segments comprising the content;
coalescing, by an operating system of the virtual-image display device, each content segment of the multiple discrete virtual-image content segments homogenously into at least one content cluster, each of the at least one content cluster being displayed in a radial virtual-image area, at least in part, within the virtual-image display device; and
accessing the content of each content cluster of the at least one content cluster, at least in part, by gesturing along a periphery of the virtual-image display device.

2. The method of claim 1, wherein the coalescing comprises coalescing each content segment of the multiple discrete virtual-image content segments based on at least one rule that is defined by the user, the at least one rule being at least one of a cluster logic rule and a cluster prioritization rule.

3. The method of claim 2, wherein the radial virtual-image area is a radial virtual-image area of a plurality of radial virtual-image areas, each of the plurality of radial virtual-image areas being discretely displayed, at least in part, within the virtual-image display device, wherein a total number of the plurality of radial virtual-image areas is defined by the content of each of the at least one content cluster.

4. The method of claim 3, further comprising modifying a dimension of each of the plurality of radial virtual-image areas to facilitate enhancing visual clarity thereof, wherein the dimension of each of the plurality of radial virtual-image areas is modified by gesturing at a periphery of the virtual-image display device.

5. The method of claim 4, wherein the coalescing comprises laterally spacing apart the radial virtual-image area from the remaining radial virtual-image areas a distance that allows the enhanced visual clarity thereof.

6. The method of claim 4, wherein the accessing comprises gesturing linearly to select the content cluster of the at least one content cluster, and navigating the content cluster by rotating along the periphery of the virtual-image display device.

7. The method of claim 3, wherein the accessing comprises interchanging the positioning of each content cluster of the at least one content cluster, at least in part, by gesturing interchangeably along the periphery of the virtual-image display device.

8. The method of claim 1, wherein the receiving comprising providing the virtual image display device, the virtual image display device comprising:
a housing having an open end and a closed end with a plurality of sidewalls extending between the open end and the closed end;
a primary display area at the closed end;
a sidewall display area on each of the plurality of sidewalls; and
a computer within the housing operably connected to the primary display area and each of the sidewall display areas;
generating a virtual-image display area opposing each sidewall display area;
generating a plurality of secondary virtual-image display areas extending outwardly from the virtual-image display areas; and
aggregating the primary display area, each of the virtual-image display areas, and each of the secondary virtual-image display areas to create a cumulative virtual-image display area, the cumulative virtual-image display area comprising each of the multiple discrete virtual-image content segments.

9. The method of claim 8, further comprising the steps of:
providing a sensor within the housing;
sensing gestures with the sensor; and
transmitting a signal from the sensor to the computer.

10. A computer program product, for use with a virtual-image display device, embodied in a non-transitory computer-readable storage medium and comprising instructions that when executed by a processor perform a method for accessing content on the virtual-image display device, the method comprising:
receiving, by a user, multiple discrete virtual-image content segments on the virtual-image display device, each of the multiple discrete virtual-image content segments comprising the content;
coalescing, by an operating system of the virtual-image display device, each content segment of the multiple discrete virtual-image content segments homogenously into at least one content cluster, each content cluster of the at least one content cluster being displayed in a radial virtual-image area, at least in part, within the virtual-image display device; and
accessing the content of each content cluster of the at least one content cluster, at least in part, by gesturing along a periphery of the virtual-image display device.

11. The computer program product of claim 10, wherein the coalescing comprises coalescing each content segment of the multiple discrete virtual-image content segments based on at least one rule that is defined by the user, the at least one rule being at least one of a cluster logic rule and a cluster prioritization rule.

12. The computer program product of claim 10, wherein the radial virtual-image area is a radial virtual-image area of a plurality of radial virtual-image areas, each of the plurality of radial virtual-image areas being discretely displayed, at least in part, within the virtual-image display device, wherein a total number of the plurality of radial virtual-image areas is defined by the content of each of the at least one content cluster.

13. The computer program product of claim 10, further comprising modifying a dimension of each of the plurality of radial virtual-image areas to facilitate enhancing visual clarity thereof, wherein the dimension of each of the plurality of radial virtual-image areas is modified by gesturing at a periphery of the virtual-image display device.

14. The computer program product of claim 13, wherein the receiving comprising providing the virtual image display device, the virtual image display device comprising:
a housing having an open end and a closed end with a plurality of sidewalls extending between the open end and the closed end;
a primary display area at the closed end;
a sidewall display area on each of the plurality of sidewalls; and
a computer within the housing operably connected to the primary display area and each of the sidewall display areas;
generating a virtual-image display area opposing each sidewall display area;
generating a plurality of secondary virtual-image display areas extending outwardly from the virtual-image display areas; and
aggregating the primary display area, each of the virtual-image display areas, and each of the secondary virtual-image display areas to create a cumulative virtual-image display area, the cumulative virtual-image display area comprising each of the multiple discrete virtual-image content segments.

15. A system for use with a virtual-image display device, the system comprising:
at least one processor; and
a computer program product embodied in a non-transitory computer-readable storage medium and comprising instructions that when executed by a processor of the at least one processor perform a method for accessing content on the virtual-image display device, the method comprising:
receiving, by a user, multiple discrete virtual-image content segments on the virtual-image display device, each of the multiple discrete virtual-image content segments comprising the content;
coalescing, by an operating system of the processor of the at least one processor, the multiple discrete virtual-image content segments homogenously into at least one content cluster, each of the at least one content cluster being displayed in a radial virtual-image area, at least in part, within the virtual-image display device; and
accessing the content of each content cluster of the at least one content cluster, at least in part, by gesturing along a periphery of the virtual-image display device.

16. The system of claim 15, wherein the processor is configured to coalesce each of the multiple discrete virtual-image content segments based on at least one rule that is defined by the user, the at least one rule being at least one of a cluster logic rule and a cluster prioritization rule.

17. The system of claim 16, wherein the radial virtual-image area is a radial virtual-image area of a plurality of radial virtual-image areas, and the processor is configured to discretely display each of the plurality of radial virtual-image areas, at least in part, within the virtual-image display device.

18. The system of claim 17, wherein the processor is configured to laterally space apart the radial virtual-image area from the remaining radial virtual-image areas a distance that allows enhanced visual clarity of the content cluster of the at least one content cluster displayed in the radial virtual-image area.

19. The system of claim 15, wherein the processor is configured to enhance visual clarity of the content cluster displayed in the radial virtual-image area by gesturing linearly to select the content cluster of the at least one content cluster, and navigate the content cluster by rotating along the periphery thereof.

20. The system of claim 15, wherein the receiving comprising providing the virtual image display device, the virtual image display device comprising:
a housing having an open end and a closed end with a plurality of sidewalls extending between the open end and the closed end;
a primary display area at the closed end;
a sidewall display area on each of the plurality of sidewalls; and
a computer within the housing operably connected to the primary display area and each of the sidewall display areas;
generating a virtual-image display area opposing each sidewall display area;
generating a plurality of secondary virtual-image display areas extending outwardly from the virtual-image display areas; and
aggregating the primary display area, each of the virtual-image display areas, and each of the secondary virtual-image display areas to create a cumulative virtual-image display area, the cumulative virtual-image display area comprising each of the multiple discrete virtual-image content segments.
